(19) United States
(12) Patent Application Publication
(10) Pub. No.: US 2023/0096872 A1
(43) Pub. Date: Mar. 30, 2023

(54) ALKALINE DRY BATTERY

(71) Applicant: Panasonic Intellectual Property Management Co., Ltd., Osaka-shi, Osaka (JP)

(72) Inventors: Yasuyuki Kusumoto, Hyogo Ken (JP); Yasufumi Takahashi, Hyogo Ken (JP); Takayuki Nakatsutsumi, Osaka Fu (JP); Atsushi Fukui, Hyogo Ken (JP)

(73) Assignee: Panasonic Intellectual Property Management Co., Ltd., Osaka-shi, Osaka (JP)

(21) Appl. No.: 17/911,492

(22) PCT Filed: Dec. 8, 2020
(86) PCT No.: PCT/JP2020/045586

§ 371 Date: Sep. 14, 2022

(30) Foreign Application Priority Data
Mar. 18, 2020 (JP) 2020-048354

(51) Int. Cl. H01M 4/62; H01M 6/06

(52) U.S. Cl. CPC H01M 4/628; H01M 6/06

(57) ABSTRACT

An alkaline dry battery including: a positive electrode; a negative electrode; a separator disposed between the positive electrode and the negative electrode; and an alkaline electrolyte retained in the positive electrode, the negative electrode, and the separator. The negative electrode includes a negative electrode active material containing zinc, and an additive. The additive includes an aromatic carboxylic acid and tin powder.

### TECHNICAL FIELD

The present disclosure relates to an improvement of the negative electrode of an alkaline dry battery.

### BACKGROUND ART

Alkaline dry batteries (alkaline manganese dry batteries) have been widely used because of their large capacity as compared to those of manganese dry batteries and a large current that can be drawn therefrom. An alkaline dry battery includes a positive electrode, a negative electrode, a separator disposed between the positive electrode and negative electrode, and an alkaline electrolyte contained in the positive electrode, negative electrode, and separator. The negative electrode includes a negative electrode active material containing zinc.

In the case of using a plurality of alkaline dry batteries in series connection in a device, it may occur that one of the alkaline dry batteries is mistakenly connected in reverse polarity, and charged. It may also occur that an alkaline dry battery, which is a primary battery, is mistakenly installed in a charger for a secondary battery, and charged.

When the alkaline dry battery is charged by misuse, hydrogen gas generates within the battery, and in association therewith, the battery internal pressure rises. The hydrogen generation increases as the charge proceeds, and when the battery internal pressure reaches a predetermined value, the safety vent is activated to release the hydrogen within the battery to the outside. Along with the release of the hydrogen to the outside, the alkaline electrolyte may leak outside, and the alkaline electrolyte having leaked outside may cause a malfunction of the device.

Patent Literature 1 proposes a size AA alkaline battery including a negative electrode principally composed of zinc functioning as an active material, a positive electrode principally composed of manganese dioxide or nickel oxyhydroxide functioning as an active material, a separator composed of a nonwoven fabric, an electrolyte composed of an aqueous solution of potassium hydroxide, and zinc oxide, the content of zinc oxide being 0.08 to 0.1 g.

Patent Literature 2 proposes an alkaline dry battery including a positive electrode, a negative electrode, a separator, and at least an alkaline electrolyte held in said separator. The negative electrode includes a zinc alloy powder as the negative electrode active material and a gelatinous alkaline electrolyte. The gel-type alkaline electrolyte contains quaternary ammonium salt in a ratio of 0.00002 M parts (M is the molecular weight of said quaternary ammonium salt) or more by weight to 100 parts by weight of zinc alloy powder. The alkaline electrolyte and the alkaline electrolyte in the gelatinous alkaline electrolyte each contain 0.3 mol/l or more of a Zn-containing compound.

Patent Literature 3 proposes alkaline dry batteries, which comprise a positive electrode containing manganese dioxide, a negative electrode containing zinc, a separator arranged between said positive electrode and said negative electrode, and an alkaline electrolyte. The air permeability of said separator is 0.5 to 5.0 ml/sec/cm², the electric potential of the manganese dioxide is 270 to 330 mV (vs. Hg/HgO), and the alkaline electrolyte is characterized in that it contains 2.0% to 4.5% by weight of zinc oxide.

Patent Literature 4 proposes an alkaline dry battery, using a caustic alkaline aqueous solution as the electrolyte, in which at least one or more compounds selected from aryl carboxylic acids, their substituted derivatives, and their salts are added as an anti-corrosion agent for the negative electrode active material.

Patent Literature 5 proposes an alkaline dry battery, which has a positive electrode, a negative electrode, a separator disposed between said positive electrode and said negative electrode, and an electrolyte contained in said positive electrode, negative electrode, and said separator. The electrolyte includes an alkaline solution, and the negative electrode includes a negative electrode active material including Zn and an additive. The additive includes at least one selected from the group consisting of benzoic acid, phthalic acid, isophthalic acid, and salts thereof. The amount of the negative electrode active material in the negative electrode is 176 to 221 parts by mass per 100 parts by mass of water in said electrolyte, and the amount of said additive in said negative electrode is 0.1 to 1.0 parts by mass per 100 parts by mass of the negative electrode active material.

Patent Literature 6 proposes a zinc-alkaline primary battery, which has a zinc negative electrode consisting mainly of corrosion-resistant zinc alloy powder of mercury-free, or mercurialized with 2% by weight or less of mercury, mixed with a conductive material in a granular, fibrous, or scaly form whose surface is alkali resistant, easily mercurialized and composed of a metal or alloy nobler than zinc.

Patent Literature 7 proposes an electrochemical battery comprising an anode containing zinc, an aqueous alkaline electrolyte, a separator, and a cathode containing manganese dioxide, wherein the anode further comprises a conductive metal powder that is physically mixed with zinc.

Patent Literature 8 proposes a gel-like negative electrode, which is a gelled negative electrode for an alkaline electrochemical cell, and the negative electrode contains Zn-containing particles, an alkaline electrolyte, a gelling agent, and two or more additives selected from the group consisting of alkali metal hydroxides, organophosphate surfactants, metal oxides, and tin.

### CITATION LIST

### Patent Literature

[PTL 1] Japanese Laid-Open Patent Publication No. 2006-156158
[PTL 2] Japanese Laid-Open Patent Publication No. 2011-216218
[PTL 3] International Publication WO2010/140295
[PTL 4] Japanese Laid-Open Patent Publication No. 861-208753
[PTL 5] International Publication WO20181163485
[PTL 6] Japanese Laid-Open Patent Publication No. S61-96665
[PTL 7] Japanese Laid-Open Patent Publication No. 2003-502808
[PTL 8] Japanese Laid-Open Patent Publication No. 2018-514932

### SUMMARY OF INVENTION

### Technical Problem

When an alkaline dry battery is kept charged by misuse, at the negative electrode, zinc precipitation due to the reduction of the zinc ions in the electrolyte proceeds, decreasing the amount of zinc ions in the electrolyte. When the zinc ions in the electrolyte are decreased to a small amount, the resistance to the zinc precipitation reaction increases significantly, and the negative electrode electric potential drops rapidly and reaches a hydrogen generation potential at an early stage. As a result, the hydrogen generation increases, and the safety vent is activated to release the hydrogen, along with which the alkali electrolyte leaks outside. It is difficult to adequately address this problem with the proposals in Patent Literatures 1 to 3. Patent Literatures 4 to 8 also do not provide a means to address the problems caused by the misuse of batteries.

### Solution to Problem

An alkaline dry battery according to an embodiment of the present disclosure includes a positive electrode, a negative electrode, a separator disposed between the positive electrode and the negative electrode, and an alkaline electrolyte retained in the positive electrode, the negative electrode, and the separator. The negative electrode includes a negative electrode active material containing zinc, and an additive. The additive includes an aromatic carboxylic acid and a tin powder.

According to the present disclosure, when the alkaline dry battery is charged by misuse, the leakage of the alkaline electrolyte to the outside of the battery can be suppressed.

### BRIEF DESCRIPTION OF DRAWING

FIG. 1 A front view, partially shown in cross section, of an alkaline dry battery in one embodiment of the present invention.

### DESCRIPTION OF EMBODIMENTS

An alkaline dry battery according to an embodiment of the present disclosure includes a positive electrode, a negative electrode, a separator disposed between the positive electrode and the negative electrode, and an alkaline electrolyte (hereinafter sometimes simply referred to as an electrolyte) retained in the positive electrode, the negative electrode, and the separator.

The negative electrode includes a negative electrode active material containing zinc, and an additive. The additive includes an aromatic carboxylic acid and tin (Sn) powder

When an alkaline dry battery is charged by misuse, the zinc ions (Zn²⁺) contained in the electrolyte are reduced at the negative electrode, causing a reaction that makes zinc precipitate on the surface of the negative electrode active material. Therefore, the negative electrode potential is maintained around −1.4 V (vs. Hg/HgO), which is the reduction potential of zinc ions. When the charge of the alkaline dry battery is further continued, the zinc ions in the electrolyte decrease, the resistance to the zinc precipitation reaction increases, and the negative electrode potential drops to or below −1.7 V (vs. Hg/HgO), which is the decomposition potential of the water in the electrolyte (hydrogen generation potential). The zinc ions in the electrolyte are present in the form of a zinc complex ion: Zn(OH)₄²⁻.

On the other hand, the inclusion of the above additives in the negative electrode accelerates the cycle of zinc corrosion (ZnO formation), ZnO dissolution, and Zn re-deposition on the surface of the negative electrode active material. By maintaining the negative electrode potential near the reduction potential of Zn ions, hydrogen generation is suppressed, and the safety valve is less likely to be activated due to a rise in internal pressure.

The mechanism for accelerating the cycle of ZnO formation, dissolution, and Zn re-deposition is not precise. Still, it is speculated that the tin powder alters the form of deposited zinc due to misuse charging and increases the specific surface area of Zn. The volume resistivity of Zn and Sn are 5.5 μΩcm and 11.5 μΩcm, respectively. Since Sn has a higher volume resistivity than Zn, Zn precipitation occurs preferentially on the Zn surface. When the tin powder is mixed with negative electrode active material powder containing Zn, the tin powder in proximity to the negative electrode active material shields part of the surface of the negative electrode active material powder. Since Zn ions bypass the surface shielded by the tin powder and precipitate, Zn tends to grow in a dendrite-like form. Thus, the specific surface area of Zn increases.

The larger specific surface area of the deposited zinc increases the reactivity of water and zinc in the electrolyte, and a relatively large amount of ZnO is formed on the zinc surface with a large specific surface area. These ZnO dissolves in the electrolyte, and aromatic carboxylic acids promote the dissolution of ZnO because they form complexes with Zn ions in the electrolyte. Zn ions released into the electrolyte due to the dissolution of ZnO are re-deposited on the surface of the negative electrode active material due to charging by misuse. This cycle continues to maintain the negative electrode potential near the zinc reduction potential and suppresses hydrogen generation due to the decrease in the negative electrode potential.

Aromatic carboxylic acid is a general term for compounds having an aromatic ring and a carboxyl group bonded directly to the aromatic ring. Aromatic carboxylic acids need at least one carboxyl group. Still, aromatic polycarboxylic acids having two or more carboxyl groups are preferred because they easily form stable complexes with Zn ions in the electrolyte. Aromatic dicarboxylic acids are particularly preferred. At least one carboxyl group of an aromatic carboxylic acid may form a salt. In other words, aromatic carboxylic acids may be aromatic carboxylic acid salts. Cations substituted for the H of the COOH group include alkali metal ions, ions of group II elements, onium cations, and ammonium ions. Examples of alkali metals include sodium and potassium. Examples of group II elements include magnesium and calcium. Aromatic carboxylic acids may be ionized in the electrolyte to exist as anions.

The aromatic ring may be a benzene ring, a naphthalene ring, or any other ring, but a benzene ring is preferred. The aromatic ring may have substituents attached to it that do not significantly interfere with the formation of complexes with Zn ions. Aromatic dicarboxylic acids include, for example, benzene dicarboxylic acids (i.e., phthalic acids) and derivatives of benzene dicarboxylic acids. Derivatives include compounds with substituents other than carboxyl groups attached to the benzene ring (e.g., methyl groups) but not esters. Among phthalic acids, terephthalic acid is particularly preferred because it is highly effective in promoting the dissolution of ZnO. Of the aromatic carboxylic acids, 90 mass % or more may be aromatic dicarboxylic acids, 90 mass % or more of the aromatic dicarboxylic acids be phthalic acids, and 90 mass % or more of the phthalic acids be terephthalic acid.

The amount of aromatic carboxylic acid (preferably aromatic dicarboxylic acid (more preferably terephthalic acid)) contained in the negative electrode may be, for example, from 0.05 parts by mass or more to 0.5 parts by mass or less per 100 parts by mass of the negative electrode active material. It also may be from 0.05 parts by mass or more to 0.3 parts by mass or less, or 0.08 parts by mass or more to 0.2 parts by mass or less per 100 parts by mass of the negative electrode active material. In this range, the effect of suppressing hydrogen generation at the time of charging due to misuse becomes sufficiently large. In addition, better discharge performance can be obtained. Aromatic carboxylic acids may be added in advance to the electrolyte used to prepare the negative electrode. The concentration of aromatic carboxylic acid in the electrolyte may be, for example, 0.05 mass % or more and 0.5 mass % or less.

The tin powder is suitable as an additive because it has a high hydrogen evolution overvoltage, and its specific gravity is close to that of zinc, making it easy to disperse uniformly in the negative electrode active material and not detrimental to the discharge reaction of the battery. The tin powder should be mainly composed of tin in a metallic state. The tin powder may be a tin alloy containing trace amounts of other elements or may contain trace amounts of tin oxides. The tin powder may be a powder that contains, for example, 20 mass % or less of elements other than tin, with the remainder being metallic tin.

When a zinc alloy is used as the negative electrode active material, the zinc alloy can contain tin. However, the tin contained in the negative electrode active material as a component of the zinc alloy has little effect on physically shielding part of the surface of the negative electrode active material and is not expected to increase the specific surface area of the zinc. It is required that the tin powder be different from the negative electrode active material, and that the particles of the negative electrode active material and tin powder be mixed.

A zinc powder and a zinc alloy powder may be used as negative electrode active materials. The zinc alloy may contain at least one selected from the group consisting of indium, bismuth, and aluminum, for example, in view of the corrosion resistance. The indium content in the zinc alloy is, for example, 0.01 mass % to 0.1 mass %, and the bismuth content is, for example, 0.003 mass % to 0.02 mass %. The aluminum content in the zinc alloy is, for example, 0.001 mass % to 0.03 mass %. In view of the corrosion resistance, the elements other than zinc preferably occupies 0.025 mass % to 0.08 mass % of the zinc alloy.

The negative electrode active material is usually used in a powder form. In view of the packability of the negative electrode and the diffusibility of the electrolyte in the negative electrode, the average particle diameter (D50) of the negative electrode material powder is, for example, 100 μm to 200 μm, preferably 110 μm to 160 μm. In the present specification, the average particle diameter (D50) refers to a median diameter in a volumetric particle size distribution. The average particle diameter can be measured by, for example, using a laser diffraction/scattering type particle size distribution analyzer.

The average particle diameter of tin powder (D50), which is used as an additive, should be smaller than the negative electrode active material powder. For example, it may be 0.1 to 100 μm or 0.1 to 10 μm. However, the average particle diameter D50s of the tin powder should not be excessively larger than the average particle diameter D50z of the negative electrode active material powder. For example, D50s/D50z<1 should be satisfied. D50s/D50z<0.1 is also acceptable.

The amount of tin powder in the negative electrode may be, for example, 0.05 parts by mass or more and 1 part by mass or less per 100 parts by mass of the negative electrode active material. It may be 0.1 part by mass or more and 0.5 part by mass or less, or 0.2 part by mass or more and 0.4 part by mass or less. In this range, the effect on the negative electrode capacity is negligibly small, and the impact of suppressing hydrogen generation during charging due to misuse is sufficiently large.

From the viewpoint of proper control of the synergistic effect of aromatic carboxylic acids and tin powder, the ratio (Mac/Ms) of the mass of aromatic carboxylic acid (Mac, preferably phthalic acid) to the mass of tin powder (Ms) in the negative electrode may be, for example, 0.05<Mac/Ms<10, or 0.05<Mac/Ms<3.

The positive electrode may contain the additives listed above. Most of the additives added to the negative electrode will remain in the negative electrode, but a small portion of the additives in the electrolyte in the negative electrode may move to the electrolyte in the positive electrode.

The alkaline dry battery according to an embodiment of the present disclosure includes, for example, a cylindrical battery and a coin battery.

A detailed description will be given below of an alkaline dry battery according to the present embodiment, with reference to the drawing. The present invention, however, is not limited to the following embodiment. Modification can be made as appropriate without departure from the scope in which the effect of the present invention can be exerted. Furthermore, any combination with another embodiment is possible.

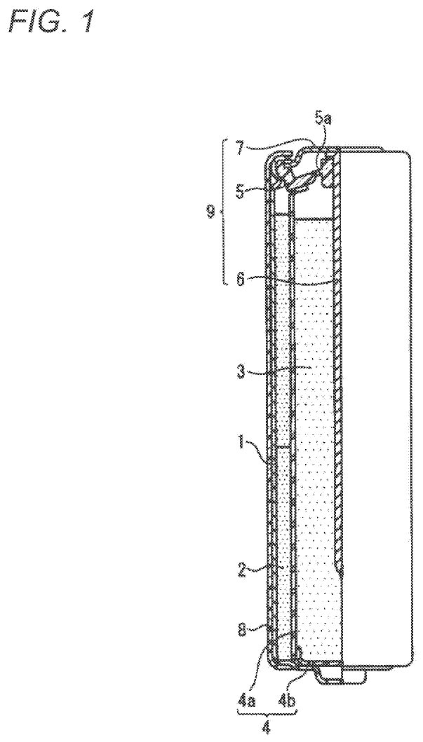

FIG. 1 is a front view of an alkaline dry battery according to one embodiment of the present disclosure, with one half side shown in cross-section. FIG. 1 illustrates an example of an inside-out type cylindrical alkaline dry battery. As illustrated in FIG. 1, the alkaline dry battery includes a hollow cylindrical positive electrode 2, a gel negative electrode 3 disposed in the hollow of the positive electrode 2, a separator 4 interposed therebetween, and an electrolyte, which are all housed in a bottomed cylindrical battery case 1 serving as a positive electrode terminal. The electrolyte used here is an aqueous alkaline solution.

The positive electrode 2 is disposed in contact with the inner wall of the battery case 1. The positive electrode 2 includes a manganese dioxide and an electrolyte. In the hollow of the positive electrode 2, the gel negative electrode 3 is packed, with the separator 4 interposed therebetween. The negative electrode 3 usually includes a negative electrode active material containing zinc and the aforementioned additive, and in addition, an electrolyte and a gelling agent.

The separator 4 has a bottomed cylindrical shape and retains an electrolyte. The separator 4 is constituted of a cylindrically-shaped separator 4a and a bottom paper 4b. The separator 4a is disposed along the inner surface of the hollow of the positive electrode 2, to provide insulation between the positive electrode 2 and the negative electrode 3. The separator disposed between the positive electrode and the negative electrode means the cylindrically-shaped separator 4a. The bottom paper 4b is disposed at the bottom of the hollow of the positive electrode 2, to provide insulation between the negative electrode 3 and the battery case 1.

The opening of the battery case 1 is sealed with a sealing unit 9. The sealing unit 9 includes a gasket 5, a negative electrode terminal plate 7 serving as a negative electrode terminal, and a negative electrode current collector 6. The negative electrode current collector 6 is inserted into the negative electrode 3. The negative electrode current collector 6 has a nail-like shape having a head and a shank, and the shank is passed through a through-hole provided in the center cylindrical portion of the gasket 5. The head of the negative electrode current collector 6 is welded to the flat portion at the center of the negative electrode terminal plate 7. The opening end of the battery case 1 is crimped onto the flange at the circumference of the negative electrode terminal plate 7, via the peripheral end portion of the gasket 5. The outer surface of the battery case 1 is wrapped with an outer label 8.

A detailed description will be given below of the alkaline dry battery.

### (Negative Electrode)

The negative electrode is obtained by mixing a Zn-containing negative electrode active material (zinc, zinc alloy, or other powder), an additive (an aromatic dicarboxylic acid and a tin powder), a gelling agent, and an electrolyte.

The gelling agents are not restricted, but water-absorbent polymers, for example, can be used. Examples of water-absorbent polymers include polyacrylic acid and sodium polyacrylate.

The gelling agent in the negative electrode is added in an amount of, for example, 0.5 to 2.5 parts by mass per 100 parts by mass of the negative electrode active material.

For viscosity adjustment and other purposes, surfactants may be added to the negative electrode. Polyoxyalkylene group-containing compounds and phosphate esters are examples of surfactants, with phosphate esters and their alkali metal salts preferred. The surfactant may be added to the electrolyte solution to prepare the negative electrode.

### (Negative Electrode Current Collector)

Examples of the material of the negative electrode current collector inserted into the gel negative electrode include a metal and an alloy. The negative electrode current collector preferably contains copper, and may be made of, for example, an alloy containing copper and zinc, such as brass. The negative electrode current collector may be plated with tin or the like, if necessary.

### (Positive Electrode)

The positive electrode usually includes a manganese dioxide serving as a positive electrode active material, and in addition, an electrically conductive agent and an electrolyte. The positive electrode may further include a binder, as needed.

The manganese dioxide is preferably an electrolytic manganese dioxide. The manganese dioxide has a crystal structure, such as an α-type, a β-type, a γ-type, a δ-type, an ε-type, a η-type, a λ-type, and a ramsdellite-type crystal structure.

The manganese dioxide is usually used in a powder form. In view of the packability of the positive electrode and the diffusibility of the electrolyte in the positive electrode, the average particle diameter (D50) of the manganese dioxide is, for example, 25 to 60 μm.

In view of the moldability and the suppression of the positive electrode expansion, the BET specific surface area of the manganese dioxide may be in a range of 20 to 50 m²/g. The BET specific surface area is obtained by measuring and calculating a surface area using a BET equation, which is a theoretical equation of multilayer adsorption. The BET specific surface area can be measured using, for example, a specific surface area meter employing a nitrogen adsorption method.

Examples of the conductive agent include carbon black, such as acetylene black, and an electrically conductive carbon material, such as graphite. The graphite may be natural graphite, artificial graphite, and the like. The conductive agent may be in the form of fibers or the like, but is preferably in the form of powder. The average particle diameter (D50) of the conductive agent is, for example, 3 to 20 μm.

The content of the conductive agent in the positive electrode per 100 parts by mass of the manganese dioxide may be, for example, 3 to 10 parts by mass, and may be 5 to 9 parts by mass.

Silver or a silver compound, such as Ag₂O, AgO, Ag₂Os, and AgNiO₂, may be added in the positive electrode, in order to allow it to absorb the hydrogen generated within the battery when the alkaline dry battery is charged by misuse.

The positive electrode can be formed by, for example, compression-molding a positive electrode material mixture including a positive electrode active material, an electrically conductive agent, an electrolyte, and if necessary, a binder, into a pellet shape. The positive electrode material mixture may be formed into flakes or granules beforehand and classified if necessary, and then compression-molded into a pellet shape.

Pellets thus formed are inserted into a battery case, which may be followed by secondary compression to bring them into close contact with the inner wall of the battery case, using a predetermined tool.

### (Separator)

Examples of the material of the separator include cellulose and polyvinyl alcohol. The separator may be, for example, a nonwoven fabric mainly composed of fibers of the above material, or a cellophane- or polyolefin-based microporous film. A nonwoven fabric and a microporous film may be used in combination. Examples of the nonwoven fabric include a mixed nonwoven fabric mainly composed of cellulose fibers and polyvinyl alcohol fibers, and a mixed nonwoven fabric mainly composed of rayon fibers and polyvinyl alcohol fibers.

In FIG. 1, the cylindrically-shaped separator 4a and the bottom paper 4b are used to constitute the bottomed cylindrical separator 4. The bottomed cylindrical separator is not limited thereto, and may be a known-shaped separator commonly used in the field of alkaline dry batteries. The separator may be constituted of one sheet of separator, or when the separator is thin, may be constituted of a plurality of the separators stacked together. A thin sheet of separator may be wound a plurality of times, to form a cylindrically-shaped separator.

The thickness of the separator is, for example, 200 to 300 μm. The separator, preferably, as a whole has the above thickness, and when the separator is thin, a plurality of the separators may be stacked to have the thickness as above.

### (Electrolyte)

The electrolyte is retained in the positive electrode, the negative electrode, and the separator. The electrolyte is, for example, an aqueous alkaline solution containing a potassium hydroxide. The potassium hydroxide concentration in the electrolyte is preferably 20 to 50 mass %. The electrolyte may further contain a zinc oxide. The zinc oxide concentration in the electrolyte is, for example, 1 to 5 mass %.

From the viewpoint of proper control of the synergistic effect of aromatic carboxylic acid and tin powder by the electrolyte, the ratio (Mk/Ms) of the mass of KOH in the alkaline dry battery (cell) to the mass of tin powder in the negative electrode (Ms) may be, for example, 20<M/Ms<580 may be used.

### (Gasket)

Examples of the gasket include polyamide, polyethylene, and polypropylene. The gasket can be produced by, for example, transfer molding using the above material, into a predetermined shape. The gasket is usually provided with a thin-walled portion for explosion-proof purpose. The thin-walled portion may be annular in shape from the viewpoint of facilitating rupture. A gasket 5 of FIG. 1 has an annular thin-walled portion 5a. From the viewpoint of making it easier to break thin-walled portions when internal pressure increases, 6,10-nylon, 6,12-nylon, and polypropylene are preferred as the material of the gasket.

### (Battery Case)

The battery case may be, for example, a bottomed cylindrical metal case. The battery case is made of, for example, a nickel-plated steel sheet. In order to improve the adhesion between the positive electrode and the battery case, the battery case is preferably a metal case whose inner surface is covered with carbon coating.

The present invention will be more specifically described below with reference to Examples and Comparative Examples. It is to be noted, however, the present invention is not limited to the following Examples.

### Example 1

An AA-size cylindrical alkaline dry batteries (LR6) as illustrated in FIG. 1 was produced in the below-described procedures (1) to (3).

### (1) Production of Positive Electrode

An electrolytic manganese dioxide powder (average particle diameter (D50): 35 μm) serving as a positive electrode active material was mixed with graphite powder (average particle diameter (D50): 8 μm) serving as an electrically conductive agent, to give a mixture. The mass ratio of the electrolytic manganese dioxide powder to the graphite powder was set to 92.4:7.6. The electrolytic manganese dioxide powder used here had a specific surface area of 41 m²/g. An electrolyte was added to the mixture, which was stirred sufficiently and then compression-molded into a flake form, to give a positive electrode material mixture. The mass ratio of the mixture to the electrolyte was set to 100:1.5.

The electrolyte used here was an aqueous alkaline solution containing potassium hydroxide (concentration: 35 mass %) and zinc oxide (concentration: 2 mass %).

The flake form of the positive electrode material mixture was crushed into a granular form, and classified through a 10- to 100-mesh sieve. Then, 11 g of the resultant granules were compression-molded into a predetermined hollow cylindrical shape of 13.65 mm in outer diameter, to form a positive electrode pellet 2. Two pellets were produced.

### (2) Production of Negative Electrode

A zinc alloy powder (average particle diameter (D50) 130 μm) serving as a negative electrode active material, a tin powder (average particle diameter (D50): 1.5 μm), terephthalic acid, electrolyte, and a gelling agent were mixed, to give a gel negative electrode 3. The electrolyte used here had the same composition as that used for the production of the positive electrode.

The zinc alloy used here was a zinc alloy (ZnBiAlIn) containing 0.02 mass % of indium, 0.01 mass % of bismuth, and 0.005 mass % of aluminum. The electrolyte used here had the same composition as that used for the production of the positive electrode.

The gelling agent used here was a mixture of a cross-linked branched polyacrylic acid and a highly cross-linked linear sodium polyacrylate.

The amount of the tin powder was 0.25 parts by mass per 100 parts by mass of the negative electrode active material. The amount of terephthalic acid was 0.14 parts by mass per 100 parts by mass of the negative electrode active material. The mass ratio of the negative electrode active material, electrolyte, and gelling agent was 100:50:1.

### (3) Assembling of Alkaline Dry Battery

A battery case 1 was obtained by coating the inner surface of a bottomed cylindrical battery case (outer diameter: 13.80 mm, wall thickness of cylindrical portion: 0.15 mm, height: 50.3 mm) made of nickel-plated steel sheet with a carbon film of approximately 10 μm thickness by applying Bunny Height manufactured by Nippon Graphite Industries, Ltd. After inserting two positive electrode pellets vertically into the battery case 1, the positive electrode pellets were pressurized to form a positive electrode 2 that was in close contact with the inner wall of the battery case 1. A bottomed cylindrical separator 4 was placed inside the positive electrode 2, and then, an electrolyte was injected thereto, to be impregnated into the separator 4. The electrolyte used here had the same composition as that used for the production of the positive electrode and the negative electrode. These were allowed to stand in this state for a predetermined period of time, to allow the electrolyte to permeate from the separator 4 into the positive electrode 2. Thereafter, 6 g of the gel negative electrode 3 was packed inside the separator 4.

The ratio (Mk/Ms) of the mass of KOH (Mk) in the alkaline battery (cell) to the mass of the tin powder (Ms) in the negative electrode was set to 114.

The separator 4 was constituted of a cylindrically-shaped separator 4a and a bottom paper 4b. The cylindrically-shaped separator 4a and the bottom paper 4b were formed using a sheet of mixed nonwoven fabric (basis weight: 28 g/m²) mainly composed of rayon fibers and polyvinyl alcohol fibers mixed in a mass ratio of 1:1. The thickness of the nonwoven fabric sheet used for the bottom paper 4b was 0.27 mm. The separator 4a was constituted by winding a 0.09-mm-thick nonwoven fabric sheet in three layers.

A negative electrode current collector 6 was prepared by press-working a typical brass (Cu content: approx. 65 mass %, Zn content: approx. 35 mass %) into a nail shape, and plating its surface with tin. The diameter of the shank of the negative electrode current collector 6 was set to 1.15 mm. The head of the negative electrode current collector 6 was electrically welded to a negative electrode terminal plate 7 made of a nickel-plated steel sheet. Then, the shank of the negative electrode current collector 6 was press-inserted into the through-hole provided at the center of a gasket 5, having a thin-walled portion safety valve mainly composed of polyamide 6,12. In this way, a sealing unit 9 composed of the gasket 5, the negative electrode terminal plate 7, and the negative electrode current collector 6 was formed.

Next, the sealing unit 9 was placed at the opening of the battery case 1. At this time, the shank of the negative electrode current collector 6 was inserted into the negative electrode 3. The opening end of the battery case 1 was crimped onto the periphery of the negative electrode terminal plate 7, with the gasket 5 interposed therebetween, to seal the opening of the battery case 1. The outside surface of the battery case 1 was wrapped with an outer label 8. In this way, an alkaline dry battery A1 was fabricated.

### [Evaluation]

The battery A1 produced in the above was subjected to the following evaluation test. One battery A1 was prepared and connected to a circuit passing a reverse connection current of 0.1 A. The battery was examined for leakage 60 minutes after the start of the reverse connection.

The above evaluation test was performed 5 times in total, and the number of leaking batteries (Number of liquid leaked) was determined.

Note that the above evaluation test was performed by simulating a case where one battery was accidentally connected in the positive and negative opposite directions when four batteries were loaded in series in a low-load (30Ω) device. The charging time of 60 minutes was set by taking into account the time required for a user to notice the abnormality of the device after installing batteries in the device, and remove the battery connected in reverse polarity from the device.

### Comparative Example 1

An alkaline dry battery B1 was fabricated and evaluated in the same manner as in Example 1, except that no tin powder was used as the additive, in the production of negative electrode.

### Comparative Example 2

An alkaline dry battery B2 was fabricated and evaluated in the same manner as in Example 1, except that no terephthalic acid was used as the additive, in the production of negative electrode.

### Comparative Example 3

In the preparation of the negative electrode, alkaline dry battery B3 was prepared and evaluated in the same manner as in Example 1, except that tin powder was not used as an additive, and a zinc alloy that is the negative electrode active material containing 0.02 mass % indium, 0.01 mass % bismuth, 0.005 mass % aluminum, and 0.01 mass % tin (ZnBiAlInSn) was used as the negative electrode active material.

### Comparative Example 4

An alkaline dry battery B4 was fabricated and evaluated in the same manner as in Example 1, except that neither tin powder nor terephthalic was used as the additive, in the production of negative electrode.

The evaluation results are shown in Table 1.

TABLE 1

| | | | | Number of |
|---|---|---|---|---|
| | Terephthalic | | Negative electrode | liquid |
| Battery | acid | Metallic Sn | active material | leaked |
| A1 | Added | Added | ZnBiAlIn | 0/5 |
| B1 | Added | Not added | ZnBiAlIn | 4/5 |
| B2 | Not added | Added | ZnBiAlIn | 4/5 |
| B3 | Added | Not added | ZnBiAlInSn | 4/5 |
| B4 | Not added | Not added | ZnBiAlIn | 5/5 |

In battery A1 of Example 1, where terephthalic acid and tin powder were added to the negative electrode, the number of liquid leaked was 0. On the other hand, in Comparative Examples 1-4, where at least one terephthalic acid and tin powder was not used, leakage was observed in more than 80% of the batteries. In Comparative Example 3, a Zn-containing alloy containing tin was used as the negative electrode active material, but it did not show the same effect as when the tin powder was used.

### Examples 2 to 5

Alkaline dry batteries A2 to A5 were fabricated and evaluated in the same manner as in Example 1, except that the amount of tin powder per 100 parts by mass of the negative electrode active material was fixed at 0.25 parts by mass, and the amount of terephthalic acid per 100 parts by mass of the negative electrode active material was varied as shown in Table 2, in the production of negative electrode. The evaluation results are shown in Table 2.

TABLE 2

| | Terephthalic | | | | Number of |
|---|---|---|---|---|---|
| | acid | Metallic Sn | | | liquid |
| Battery | (part by mass) | (part by mass) | Mac/Ms | Mk/Ms | leaked |
| A2 | 0.05 | 0.25 | 0.2 | 114 | 0/5 |
| A3 | 0.1 | 0.25 | 0.4 | 114 | 0/5 |
| A1 | 0.14 | 0.25 | 0.56 | 114 | 0/5 |
| A4 | 0.2 | 0.25 | 0.8 | 114 | 0/5 |
| A5 | 0.5 | 0.25 | 2 | 114 | 0/5 |

### Examples 6 to 9

Alkaline dry batteries A6 to A9 were fabricated and evaluated in the same manner as in Example 1, except that the amount of terephthalic acid per 100 parts by mass of the negative electrode active material was fixed at 0.14 parts by mass, and the amount of tin powder per 100 parts by mass of the negative electrode active material was varied as shown in Table 3, in the production of negative electrode. The evaluation results are shown in Table 3.

TABLE 3

| | Terephthalic | | | | Number of |
|---|---|---|---|---|---|
| | acid | Metallic Sn | | | liquid |
| Battery | (part by mass) | (part by mass) | Mac/Ms | Mk/Ms | leaked |
| A6 | 0.14 | 0.05 | 2.8 | 570 | 0/5 |
| A7 | 0.14 | 0.1 | 1.4 | 285 | 0/5 |
| A1 | 0.14 | 0.25 | 0.56 | 114 | 0/5 |
| A8 | 0.14 | 0.5 | 0.25 | 57 | 0/5 |
| A9 | 0.14 | 1 | 0.14 | 29 | 0/5 |

Tables 2 and 3 show that the leakage does not occur when the amount of tin powder contained in the negative electrode is controlled to be 0.05 parts by mass or more and 1 part by mass or less per 100 parts by mass of the negative electrode active material, or when the amount of aromatic carboxylic acid contained in the negative electrode is controlled to be 0.05 parts by mass or more and 0.5 parts by mass or less per 100 parts by mass of the negative electrode active material. Therefore, it can be seen that the use of additives in the above range can suppress hydrogen generation more effectively.

### INDUSTRIAL APPLICABILITY

The alkaline dry batteries in the embodiments of the present disclosure can be applied to any equipment (especially low-load equipment) that is powered by dry batteries. Examples of low-load devices include radios, watches, and portable music players.

### REFERENCE SIGNS LIST

1 battery case
2 positive electrode
3 negative electrode
4 bottomed cylindrical separator
4a cylindrically-shaped separator
4b bottom paper
5 gasket
5a thin-walled portion
6 negative electrode current collector
7 negative electrode terminal plate
8 outer label
9 sealing unit

1. An alkaline dry battery, comprising:
a positive electrode; a negative electrode; a separator disposed between the positive electrode and the negative electrode; and an alkaline electrolyte retained in the positive electrode, the negative electrode, and the separator,
the negative electrode including a negative electrode active material containing zinc, and an additive,
the additive including aromatic carboxylic acid and tin powder.

2. The alkaline dry battery according to claim 1, wherein the tin powder is retained in the negative electrode in an amount of 0.05 parts by mass or more and 1 part by mass or less per 100 parts by mass of the negative electrode active material.

3. The alkaline dry battery according to claim 1, wherein the aromatic carboxylic acid is retained in the negative electrode in an amount of 0.05 parts by mass or more and 0.5 part by mass or less per 100 parts by mass of the negative electrode active material.

4. The alkaline dry battery according to claim 1, wherein the aromatic carboxylic acid includes aromatic dicarboxylic acid.

5. The alkaline dry battery according to claim 4, wherein the aromatic dicarboxylic acid includes phthalic acid.

6. The alkaline dry battery according to claim 5, wherein the phthalic acid includes terephthalic acid.
